(19) United States
(12) Patent Application Publication
(10) Pub. No.: US 2014/0095464 A1
(43) Pub. Date: Apr. 3, 2014

(54) INFORMATION PROVIDING SYSTEM, INFORMATION PROVIDING DEVICE, INFORMATION PROVIDING METHOD AND PROGRAM

(71) Applicant: FUJIFILM Corporation, Tokyo (JP)

(72) Inventor: Ken MASUDA, Tokyo (JP)

(73) Assignee: FUJIFILM Corporation, Tokyo (JP)

(21) Appl. No.: 14/035,204

(22) Filed: Sep. 24, 2013

(30) Foreign Application Priority Data
Sep. 28, 2012 (JP) 2012-218174
Oct. 15, 2012 (JP) 2012-228006

(51) Int. Cl. G06F 17/30

(52) U.S. Cl. CPC G06F 17/30864
USPC 707/706

(57) ABSTRACT

The information providing device comprises a display unit; a first obtaining unit for obtaining the content through the network to to cause the display unit to display the content; an extraction unit for extracting a target phrase for search from the content; a search unit for sequentially searching contents on the network for the phrase to obtain a number of contents hit in a search and numbers of views of the contents; a second obtaining unit for obtaining a content whose number of views is largest when the obtained number of contents is equal to or lower than a given number; and a control unit for extracting a portion of the obtained content as the related information, and causing the display unit to sequentially display the related information in synchronization with a speed at which the user views the content.

### BACKGROUND OF THE INVENTION

The present invention relates to an information providing system, an information providing device, an information providing method and a program for displaying related information about a phrase or an image in a content when viewing the content on the network.

When reading a text such as an article posted on the Internet web page, for example, the reader may often encounter an unfamiliar phrase or a phrase whose meaning the reader wants to anew confirm. In such the case, there is a problem that it is bothering and often stressful to repeat the processes of: conducting a search by using a web page of a search engine (search page); reading an article relating to the phrase on the different web page to confirm the meaning of the phrase or the like; and thereafter returning to the original article on the former web page.

Prior art references which are relating to the present invention include JP 10-326280 A, JP 11-161398 A and JP 2008-123256 A.

JP 10-326280 A describes an electronic dictionary which retrieves various information from a dictionary stored in a storage medium and displays the information on a display device, in which main headings of the retrieved items from the dictionary are displayed in a specific display area on a screen, and reading of each of the items in the main headings appears in a balloon help when a cursor of a pointing device is pointed to the main heading of the item displayed in the display area.

JP 11-161398 A describes a user instructing method performed on a computer system, in which an interactive example is performed, an annotation corresponding to the interactive example is provided in synchronization with the interactive example, and a screen of the computer system displays multiple windows one of which shows an annotation and another of which shows an output from the interactive example.

JP 2008-123256 A describes a management method for managing terminology including a technical term or proper name taken out from a hand-written document or drawing, or from electronic data, which stores the term with a situation under which the term is used, an operation in association with the term and an expected result following the operation as its retrieval keys. By the method, the term is retrieved by using the situation under which the term is used, the operation in association with the term and the expected result following the operation as the retrieval keys.

### SUMMARY OF THE INVENTION

An object of the present invention is to provide an information providing system, an information providing device, an information providing method and a program which can automatically display related information about a phrase or an image in a content when viewing the content on a network.

In order to achieve the above-described object, the present invention provides an information providing device which displays related information about a phrase or an image in a content when a user views the content on a network, comprising:

a display unit for displaying the content and the related information;

a first obtaining unit for obtaining the content through the network to to cause the display unit to display the content;

an extraction unit for extracting a target phrase or a target image for search from the content obtained by the first obtaining unit;

a search unit for sequentially searching contents on the network for the phrase or the image extracted by the extraction unit by using a search engine to obtain a number of contents hit in a search and numbers of views of the contents hit in a search;

a second obtaining unit for obtaining a content whose number of views is largest among the contents hit in the search when the number of contents obtained by the search unit is equal to or lower than a given number; and

a control unit for extracting a portion of the content obtained by the second obtaining unit corresponding to the target phrase or the target image as the related information, and causing the display unit to sequentially display the related information in synchronization with a speed at which the user views the content displayed on the display unit.

Also, the present invention provides an information providing system comprising:

a server which is connected to a network and which stores contents; and

the information providing device described above which accesses the contents stored in the server through the network.

Also, the present invention provides an information providing method which displays related information about a phrase or an image in a content when a user views the content on a network, comprising:

a first step of obtaining the content through the network to cause a display unit to display the content;

a second step of extracting a target phrase or a target image for search from the content obtained in the first step;

a third step of sequentially searching contents on the network about the phrase or the image extracted in the second step by using a search engine to obtain a number of contents hit in a search and numbers of views of the contents hit in a search;

a fourth step of obtaining a content whose number of views is largest among the contents hit in the search when the number of contents obtained in the third step is equal to or lower than a given number, and

a fifth step of extracting a portion of the content obtained in the fourth step corresponding to the target phrase or the target image as the related information, and causing the display unit to sequentially display the related information in synchronization with a speed at which the user views the content displayed on the display unit.

Also, the present invention provides a non-transitory computer readable recording medium having recorded thereon a program adapted to cause a computer to execute each of the steps of the information providing method described above.

According to the present invention, related information about phrases or images in a content can be automatically displayed in sequence on a display unit in conformity with a speed at which a user views the content displayed on the display unit.

### BRIEF DESCRIPTION OF THE DRAWINGS

FIG. 1 is a block diagram illustrating a configuration of an embodiment of an information providing system of the invention.

FIG. 2 is a block diagram illustrating the configuration of the information providing system shown in FIG. 1.

FIG. 3 is a conceptual diagram illustrating an example of a text on a web page.

FIG. 4 is a conceptual diagram illustrating an example of a positional relationship between the text on the web page and its explanatory text.

FIG. 5 is a conceptual diagram illustrating another example of a positional relationship between the text on the web page and its explanatory text.

FIGS. 6A and 6B are conceptual diagrams illustrating mobile terminals held respectively in a vertical direction and in a lateral direction.

### DETAILED DESCRIPTION OF THE INVENTION

The information providing system, the information providing device, the information providing method, and the program of the invention are described in detail below with reference to preferred embodiments shown in the accompanying drawings.

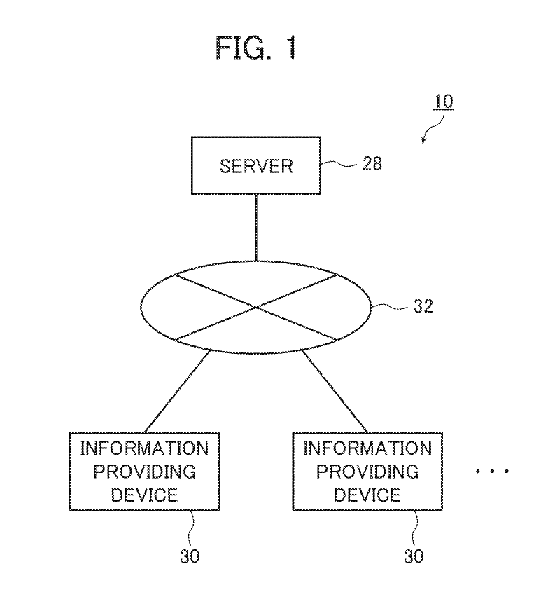

FIG. 1 is a block diagram illustrating a configuration of an embodiment of the information providing system of the invention. When a user reads a text such as an article posted on a web page on the Internet 32, the information providing system 10 illustrated in the drawing automatically displays an explanatory text about a phrase which is contained in the text and with which many users are unfamiliar in conformity with a speed of the user to read the text.

The information providing system 10 includes: a server 28 which is connected to the Internet 32 and stores various web pages; and at least one information providing device 30 which accesses the web pages stored in the server 28 through the Internet 32.

The information providing device 30 comprises, for example, a personal computer, a notebook computer, a tablet computer or a mobile terminal such as a smart phone with a display device like a liquid crystal display as well as a program which works thereon.

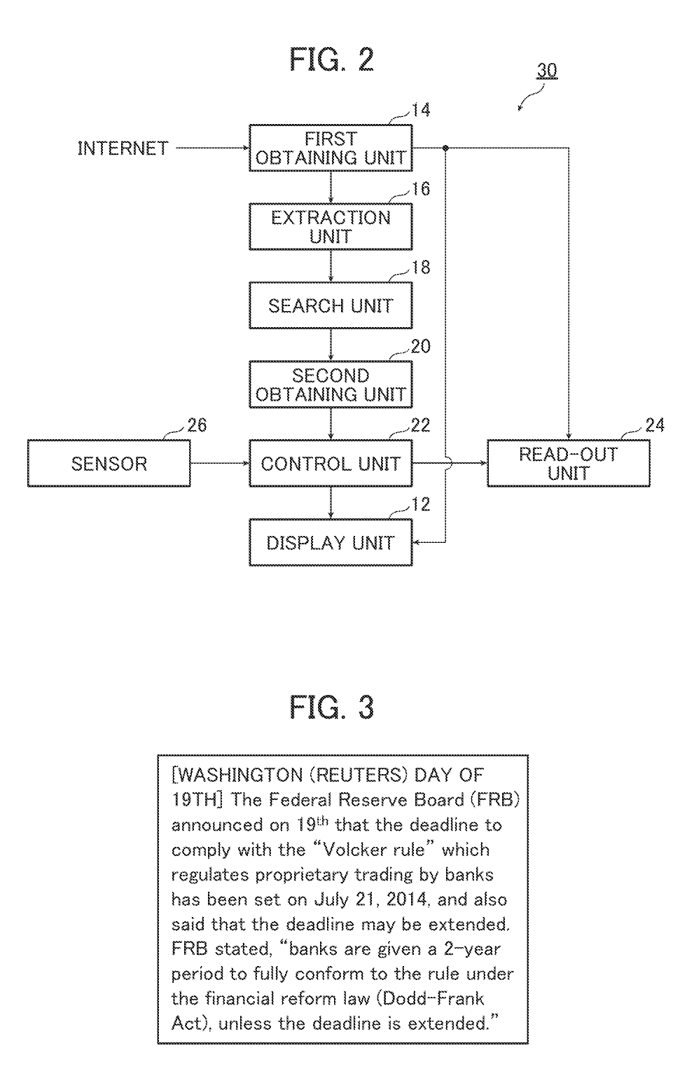

As illustrated in FIG. 2, the information providing device 30 includes a display unit 12, a first obtaining unit 14, an extraction unit 16, a search unit 18, a second obtaining unit 20, a control unit 22, a read-out unit 24 and a sensor 26.

The display unit 12 displays a text on a web page obtained by the first obtaining unit 14 or displays an explanatory text extracted by the control unit 22 as later described.

The first obtaining unit 14 obtains a text (data thereof) such as an article posted on a web page from the server 28 through the Internet 32 to have the text displayed on the display unit 12.

The extraction unit 16 extracts target phrases for searches from the text of the web page obtained by the first obtaining unit 14.

The search unit 18 searches the web pages on the Internet 32 stored in the server 28 about the target phrases which were extracted by the extraction unit 16 one after another by using, for example, a web page of a search engine (search page) on the Internet to obtain a number of web pages hit in each of the searches (a number of hits) and numbers of the respective page views.

When the number of hits obtained by the search unit 18 is equal to or less than a predetermined number, the second obtaining unit 20 obtains from the server 28 a text (data thereof) on a web page which has the largest number of page views among the found web pages.

The control unit 22 extracts a portion corresponding to the target phrase as its explanatory text from the text on the web page obtained by the second obtaining unit 20 and causes the display unit 12 to display the explanatory text one from another in conformity with a speed of the user to read a text on the web page displayed on the display unit 12, in other words, with the user's perceptual speed.

In addition, when the information providing device 30 comprises a mobile terminal, as described later, the control unit 22 controls the timing to display the explanatory text for each line of the text on the web page obtained by the first obtaining unit 14 based on movements of the mobile terminal in the horizontal direction detected by the sensor 26 or causes the display unit 12 to display an advertisement corresponding to the web page displayed thereon if the sensor 26 detects movements of the mobile terminal in the vertical direction.

The read-out unit 24 reads out the text on the web page or the explanatory text displayed on the display unit 12, that is, the text on the web page obtained by the first obtaining unit 14 or the explanatory text extracted by the control unit 22.

When the information providing device 30 comprises a mobile terminal, the sensor 26 detects movements of the user's hand holding the mobile terminal, i.e., movements of the mobile terminal. Information on the movements of the mobile terminal detected by the sensor 26 is supplied to the control unit 22.

Described below is how the information providing system 10 operates in accordance with the information providing method of the invention.

First, the user enters an Uniform Resource Locator (URL) of an interested web page into a Web browser, and the first obtaining unit 14 obtains from the server 28 through the Internet 32 a text (data thereof) on the web page at the URL entered by the user to have the text displayed in a display window on the Web browser displayed on the display unit 12.

Once the text on the web page obtained by the first obtaining unit 14 is displayed on the display unit 12, the user can read the text of the web page on the display unit 12 or cause the read-out unit 24 to read out the text to thereby hear a voice reading out the text.

On a usual web page, a text is written horizontally and is supposedly read from left to right and downward.

Subsequently, the extraction unit 16 extracts a target phrase from the text of the web page obtained by the first obtaining unit 14, i.e., from the text of the web page displayed on the display unit 12.

The search unit 18 searches the web pages on the Internet 32 about the target phrases which were extracted by the extraction unit 16 one after another by using a search page on the Internet to obtain a number of web pages hit in each of the searches and numbers of the respective page views.

Here, the method for extracting the target phrase to be searched and the method for searching the phrase are described.

For example, the extraction unit 16 separates the text of the web page displayed on the display unit 12 at each of the signs such as (, ), “, ”, <, >, and the like to extract character strings of signs and character strings not of signs. The character strings not of signs represent the target phrases.

The search unit 18 enters the character strings of signs and character strings not of signs extracted by the extraction unit 16 one after another into a search box (search window) on a search page to sequentially perform searches at a constant time interval. At this time, if entering a character string of a sign into the search box, the search unit 18 deletes the entered character string of the sign together with a character string not of a sign which was previously entered in the search box. In this manner, only character strings not of signs, i.e., only target phrases are sequentially left in the search box about which searches are made.

In an example as illustrated in FIG. 3, the search unit 18 sequentially enters the respective character strings of signs and character strings not of signs of the text in the following order:

```
    the Federal Reserve Board
    (
    FRB
    )
    announced on 19th that the deadline to comply with the
    “
    Volcker rule
    ”
    which regulates proprietary trading by banks has been set
on July 21
    ,
    2014
    ,
    and also said that the deadline may be extended
    .
```

In this example, if the character string of “(” is entered after the character string of “the Federal Reserve Board,” the character string of “(” will be removed together with the character string of “the Federal Reserve Board” from the search box. Thereafter, the character string of “FRB” after the character string of “(” is entered in the search box for a search. The same procedure is repeated on the following character strings.

Subsequently, when the number of hits obtained by the search unit 18 is equal to or fewer than a predetermined number, the second obtaining unit 20 obtains from the server 28 a text (data thereof) of a web page which has the largest number of views among the found web pages.

Here, it can be expected that an unfamiliar phrase for many users, i.e., a phrase for which an explanatory text should be displayed has a small number of hits. In the present embodiment, the second obtaining unit 20 determines that a phrase searched by the search unit 18 having a number of hits smaller than the given number is a phrase for which its explanatory text should be displayed. On the other hand, the second obtaining unit 20 determines that a phrase searched by the search unit 18 having a number of hits larger than the given number is a familiar phrase to many users, for which it is not necessary to display an explanatory text.

The second obtaining unit 20 determines that a web page having the largest number of views among the web pages hit in the search includes the most reliable text as an explanatory text for the target phrase.

The control unit 22 then extracts a portion corresponding to the target phrase as an explanatory text from the text of the web page obtained by the second obtaining unit 20 and causes the display unit 12 to display the explanatory text one after another in synchronization with the perceptual speed of the user to read the text of the web page displayed on the display unit 12.

In an example where the display unit 12 displays a text of the web page as illustrated in FIG. 3, as reading from left to right and downward, many users first encounter a question as to what “Volcker rule” means.

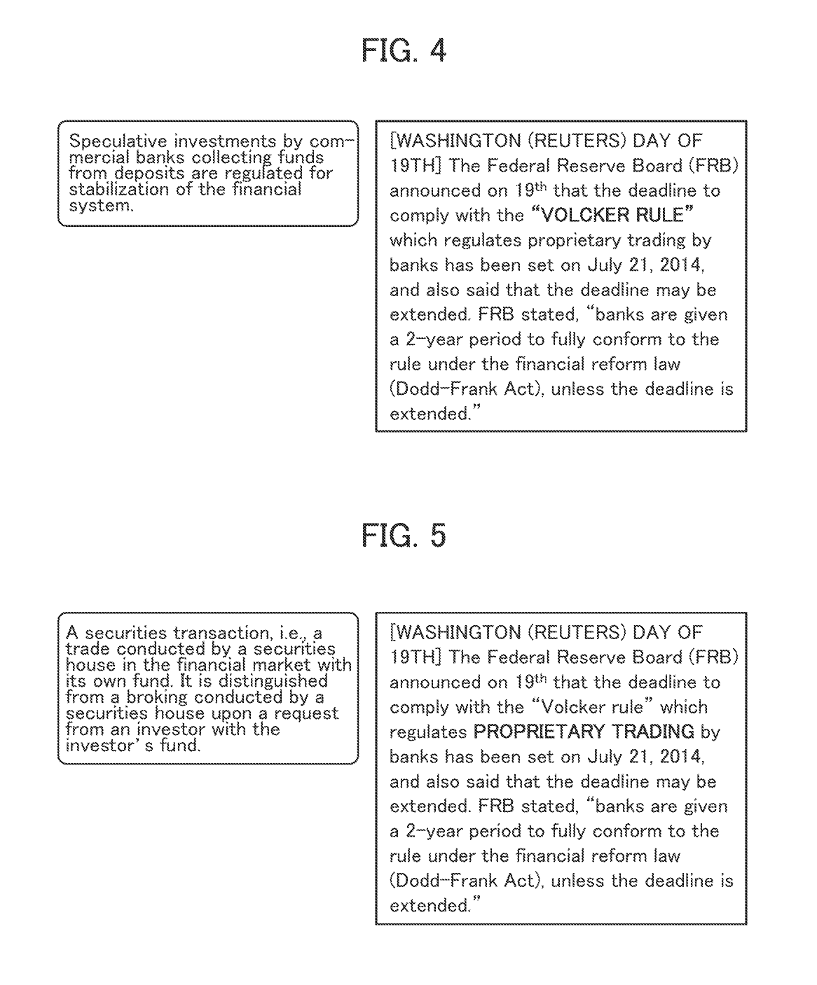

In such the case, as the user continues reading the text illustrated in FIG. 3, its explanatory text is displayed at the time when the user reads the phrase “Volcker rule” on, for example, the left side to the position where the phrase “Volcker rule” shows as shown in bold in FIG. 4. The explanatory text for the “Volcker rule” disappears at the time when the user finishes reading the explanatory text.

Subsequently, continuing to read the text as illustrated in FIG. 3, many users encounter a next question as to what is meant by the phrase “proprietary trading” which appears shortly after the “Volcker rule.”

At this time, also, its explanatory text is displayed at the time when the user reads the phrase “proprietary trading” on the left side to the position where the phrase “proprietary trading” shows as shown in bold in FIG. 5 and then disappears when the user finishes reading the explanatory text.

As the user further continues to read the text illustrated in FIG. 3, a phrase “Dodd-Frank Act” then appears. Its explanatory text for the phrase is likewise displayed on the left side to the position where the phrase “Dodd-Frank Act” shows and then disappears when the user finishes reading the explanatory text.

Subsequently, in the similar manner, when reading a phrase which is unfamiliar to many users and thus many users should have a question as to its meaning, its explanatory text is displayed on the left side to the position where the phrase shows and then disappears when the user finishes reading the explanatory text.

Accordingly, the information providing system 10 causes the display unit 12 to automatically display explanatory texts of the phrases included in a text one after another at the speed of the user to read the text of the web page displayed on the display unit 12.

Meanwhile, in some cases, the web page having the largest number of views among the web pages hit in the search as a result of search by the search unit 18 coincides with the web page originally displayed on the display unit 12. In such the case, i.e., in the case where the web page including the text obtained by the first obtaining unit 14 coincides with the web page including the text obtained by the second obtaining unit 20, the control unit 22 does not cause the display unit 12 to display an explanatory text.

An explanatory text of each target phrase is displayed on the display unit 12 for a time period corresponding to the number of words contained in the explanatory text. In particular, the control unit 22 displays an explanatory text while calculating not only the rate at which the user reads the text of the web page displayed on the display unit 12 but also the rate at which the user reads the explanatory text. However, in case where phrases of which explanatory texts should be displayed continuously appear, different explanatory texts are sequentially displayed. Hence, each explanatory text preferably disappears before the next explanatory text is displayed.

Next, the positional relationship between a text of a web page and its explanatory text displayed on the display unit 12 will be described.

A text on a web page displayed on the display unit 12 is typically written horizontally and is read from left to right and downward. Therefore, when the explanatory text appears on the left side to the text of the web page, i.e., when the explanatory text appears in the opposite direction to the direction of reading the text, the user's hand holding the information providing device 30 comprising a mobile terminal may be easily moved in the horizontal direction. Accordingly, the control unit 22 causes the explanatory text to be displayed on the left side to the target phrase to which the explanatory text corresponds.

It should be noted that the explanatory text is not necessarily placed on the left side to the text on the web page. When the information providing device 30 does not comprise a mobile terminal but a personal computer or the like, the timing to display an explanatory text can be controlled by, in place of movements of the holding hand of the user, sequentially highlighting character strings contained in the text of the web page displayed on the display unit 12, for instance.

Next, the timing of the control unit 22 to cause the display unit 12 to display an explanatory text is described.

It is essential that an explanatory text for a target phrase be displayed in conformity with the speed at which the user reads a text of a web page displayed on the display unit 12. Therefore, in order to display an explanatory text at a time the user reads the target phrase, it is preferable to make the following ingenuities (1) to (6).

(1) The control unit 22 controls the timing to display an explanatory text on an assumption that the user continues to read a text of a web page displayed on the display unit 12 at a constant speed.

For example, the control unit 22 counts a number of words from the top to a target phrase of a text of the web page displayed on the display unit 12, sets a certain number of seconds as a time necessary for the user to read a word, and calculates a time until the user's reading reaches the target phrase. Accordingly, the control unit 22 can cause the display unit 12 to display an explanatory text corresponding to the target phrase when the time until the user's reading reaches each target phrase lapsed.

(2) The control unit 22 causes the display unit 12 to display a text of a web page in a font color (display color) same as the background color, and sequentially changes the font color and the background color into different colors from each other in the order that the user reads the text.

For example, the font color and the background color of the text are first black, and the background color is locally turned to white in the order the user's reading proceeds. Accordingly, the speed at which the user reads the text can be controlled, enabling to control the timing to display an explanatory text in accordance with the speed of the user to read the text.

Here, the background color is locally turned to white sequentially in the timing of a constant time period determined by each line, every given number of words or the like. Furthermore, not the background color but the font color may be locally turned to white sequentially, or as another example of ingenuities, character strings included in the text of the web page displayed on the display unit 12 may be sequentially highlighted.

(3) When the information providing device 30 comprises a mobile terminal, and the mobile terminal being held by the user's hand, the text of the web page displayed on the display unit 12 is sequentially read such that each line of the text is read from left to right (to the next line), left to right (to the next line) and so on, the sensor 26 detects small movements of the user's hand in the horizontal direction, and the control unit 22 controls the timing to display an explanatory text for each line of the text based on the movements of the mobile terminal in the horizontal direction detected by the sensor 26.

Alternatively, by intentionally moving the mobile terminal in the horizontal direction to move to a new line of the text, the user may give an instruction of the timing to display an explanatory text for each line of the text. When the user gives an instruction of the timing to display an explanatory text, the sensor 26 can detect the movements with the improved accuracy.

When a text of a web page is read from left to right and downward, and if an explanatory text is displayed on the right side to the target phrase, reading of the text cannot be continued. Hence, it is essential that an explanatory text be displayed on the left side to the target phrase.

(4) When causing the read-out unit 24 to read out a text of a web page displayed on the display unit 12, the control unit 22 controls the timing to display an explanatory text based on the speed of the read-out unit 24 to read out the text, that is, the speed of the user to hear the text.

(5) When an explanatory text is displayed on the display unit 12, based on the assumption that the user reads the explanatory text at a constant speed and that after reading the explanatory text, the user returns to the original text of the web page to continue to read it, the control unit 22 controls the timing to display the next explanatory text based not only on the number of words of the original text of the web page but on the total number of words also counting the number of words of the explanatory text.

When the explanatory text includes an image such as a still image, a certain amount of time is added as extra time for the user to view the image. When the explanatory text includes a video such as a movie, an amount of time for replaying the video is similarly added. When a line of the explanatory text exceeds a given number of words, and the user's hand holding the terminal mobile moves in the horizontal direction when reading the explanatory text, it would be no problem if the display frame of the explanatory text overlaps the display frame of the original text of the web page. In other words, even if the original text of the web page is hidden under the explanatory text and thus is unreadable, it is still no problem since the user is reading the explanatory text at this time.

(6) When causing the read-out unit 24 to read out the explanatory text displayed on the display unit 12, the control unit 22 controls the timing to display the explanatory text based on the speed of the read-out unit 24 to read out the explanatory text, that is, the speed of the user to hear the explanatory text.

Accordingly, timing for the user to return from the explanatory text to the original text of the web page can be controlled.

Next, display of an advertisement at the time of search is described.

With the spread of the information providing system 10, if the frequency to use the search page on the Internet by users decreases, it will be expected that the frequency to display a pay-per-click type advertisement displayed on the search page will decrease, and thus the number of clicks of the advertisement will also decrease.

Therefore, the information providing device 30 has a function to display an advertisement when the user is reading a text of the web page displayed on the display unit 12, i.e., when the search unit 18 is searching about a target phrase.

That is, when the information providing device 30 comprises a mobile terminal, if the user moves the mobile terminal in the vertical direction, for example, the sensor 26 in the information providing device 30 detects the vertical movements. When the sensor 26 detects the vertical movements of the mobile terminal, the control unit 22 causes the display unit 12 to display an advertisement corresponding to the web page displayed on the display unit 12. If there are three advertisements corresponding to the web page displayed on the display unit 12, for example, the three advertisements are sequentially displayed at a given time interval.

In another example, on the other hand, once the user moves the mobile terminal in the horizontal direction, the sensor 26 likewise detects the horizontal movements of the mobile terminal. When the sensor 26 detects the horizontal movements of the mobile terminal, the control unit 22 causes the display unit 12 to display the original web page.

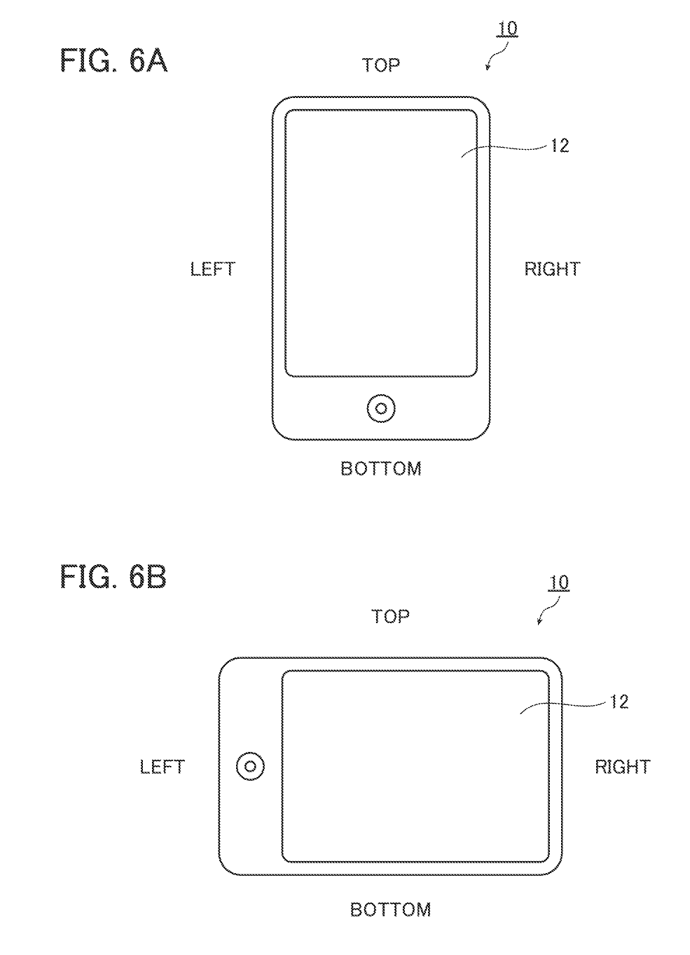

Normally, the mobile terminal has a vertically long shape, and as illustrated in FIG. 6A, when the user is holding the mobile terminal in the vertical direction, the mobile terminal has the up-and-down direction in conformity with the up-and-down direction of the drawing, i.e., the longitudinal direction of the mobile terminal, while the mobile terminal has the horizontal direction in conformity with the horizontal direction of the drawing, i.e., the width direction of the mobile terminal. In the meantime, as illustrated in FIG. 6B, when the user is holding the mobile terminal in the lateral direction, the mobile terminal has the up-and-down direction in conformity with the up-and-down direction of the drawing, i.e., the width direction of the mobile terminal, while the mobile terminal has the horizontal direction in conformity with the horizontal direction of the drawing, i.e., the longitudinal direction of the mobile terminal.

An advertisement corresponding to the web page displayed on the display unit 12 is posted on the web page by a request of an advertiser.

A pay-per-click type advertisement is effected by, for example, the user clicking the pay-per-click type advertisement displayed on the search page, allowing its advertisement web page to be displayed. On the contrary, the information providing device 30 sequentially displays advertisements corresponding to the web page displayed on the display unit 12 when the user moves the mobile terminal in the vertical direction, supposing that the user clicks the advertisements.

The information providing method of the present invention can be operated on the information providing system or the information providing device which operates in accordance with the information providing method, or by the program to cause a computer to execute each step of the information providing method.

The present invention can be operated not only on the web site on the Internet but also when a user views a content stored in a server through a network, and related information about a phrase or image in the content is displayed at the speed at which the user views the content.

In such the case, examples of the network include a local area network (LAN) and the Internet, examples of the content include a text, an image and a web page, and examples of the related information include an explanatory text and an image related to the target image.

This invention is basically as described above.

While the present invention has been described above in detail, the invention is not limited to the above embodiments, and various improvements and modifications may be made without departing from the spirit and scope of the invention.

What is claimed is:

1. An information providing device which displays related information about a phrase or an image in a content when a user views the content on a network, comprising:
a display unit for displaying the content and the related information;
a first obtaining unit for obtaining the content through the network to to cause the display unit to display the content;
an extraction unit for extracting a target phrase or a target image for search from the content obtained by the first obtaining unit;
a search unit for sequentially searching contents on the network for the phrase or the image extracted by the extraction unit by using a search engine to obtain a number of contents hit in a search and numbers of views of the contents hit in a search;
a second obtaining unit for obtaining a content whose number of views is largest among the contents hit in the search when the number of contents obtained by the search unit is equal to or lower than a given number; and
a control unit for extracting a portion of the content obtained by the second obtaining unit corresponding to the target phrase or the target image as the related information, and causing the display unit to sequentially display the related information in synchronization with a speed at which the user views the content displayed on the display unit.

2. The information providing device according to claim 1,
wherein the control unit is adapted to control timing to display the related information on an assumption that the user views the content displayed on the display unit at a constant speed.

3. The information providing device according to claim 2,
wherein the control unit is adapted to control the timing to display the related information on an assumption that the user views the related information displayed on the display unit at a constant speed.

4. The information providing device according to claim 1,
wherein the control unit is adapted to control a speed at which the user views the content displayed on the display unit by having a display color of the content displayed on the display unit be same as a background color and sequentially changing the display color and the background color of the content displayed on the display unit into different colors from each other in an order of the user to view the content, to thereby control timing to display the related information based on the speed at which the user views the content displayed on the display unit.

5. The information providing device according to claim 1,
wherein the control unit is adapted to control a speed at which the user reads a text in the content displayed on the display unit by sequentially highlighting character strings of the text in the content displayed on the display unit, to thereby control timing to display the related information based on the speed at which the user reads the text in the content displayed on the display unit.

6. The information providing device according to claim 1,
wherein the information providing device comprises a mobile terminal including a sensor for detecting movements of the mobile terminal,
wherein the content displayed on the display unit is adapted to be viewed from left to right and downward by the user, and
wherein the control unit is adapted to control timing to display the related information for each line of the content displayed on the display unit based on horizontal movements of the mobile terminal detected by the sensor.

7. The information providing device according to claim 1,
further comprising a read-out unit for reading out the content displayed on the display unit,
wherein the control unit is adapted to control timing to display the related information based on a speed at which the read-out unit reads out the content displayed on the display unit.

8. The information providing device according to claim 7,
wherein the read-out unit is further adapted to read out the related information displayed on the display unit, and
wherein the control unit is further adapted to control the timing to display the related information based on a speed at which the read-out unit reads out the related information.

9. The information providing device according to claim 1,
wherein the information providing device comprises a mobile terminal including a sensor for detecting movements of the mobile terminal, and
wherein the control unit is adapted to cause the display unit to display an advertisement corresponding to the content displayed on the display unit when the sensor detects movements of the mobile terminal in a vertical direction.

10. The information providing device according to claim 1,
wherein the content displayed on the display unit is adapted to be viewed from left to right and downward by the user, and
wherein the control unit is adapted to cause the display unit to display the related information on a left side to the target phrase or the target image to which the related information corresponds.

11. The information providing device according to claim 1,
wherein the control unit is adapted not to cause the display unit to display the related information when the content obtained by the first obtaining unit coincides with the content obtained by the second obtaining unit.

12. The information providing device according to claim 1,
wherein the extraction unit is adapted to separate a text in the content displayed on the display unit at signs to extract character strings of signs and character strings not of signs, each of the character strings not of signs becoming the target phrase,
wherein the search unit is adapted to sequentially enter the character strings of signs and the character strings not of signs extracted by the extraction unit into a search box of the search engine to sequentially search thereabout at a constant time interval, and
wherein, when entering a character string of a sign into the search box, the search unit is adapted to delete the entering character string of the sign together with a character string not of a sign previously entered in the search box.

13. An information providing system comprising:
a server which is connected to a network and which stores contents; and
the information providing device according to claim 1 which accesses the contents stored in the server through the network.

14. An information providing method which displays related information about a phrase or an image in a content when a user views the content on a network, comprising:
a first step of obtaining the content through the network to cause a display unit to display the content;
a second step of extracting a target phrase or a target image for search from the content obtained in the first step;
a third step of sequentially searching contents on the network about the phrase or the image extracted in the second step by using a search engine to obtain a number of contents hit in a search and numbers of views of the contents hit in a search;
a fourth step of obtaining a content whose number of views is largest among the contents hit in the search when the number of contents obtained in the third step is equal to or lower than a given number, and
a fifth step of extracting a portion of the content obtained in the fourth step corresponding to the target phrase or the target image as the related information, and causing the display unit to sequentially display the related information in synchronization with a speed at which the user views the content displayed on the display unit.

15. A non-transitory computer readable recording medium having recorded thereon a program adapted to cause a computer to execute each of the steps of the information providing method according to claim 14.
